(19) United States
(12) Patent Application Publication
(10) Pub. No.: US 2013/0093983 A1
(43) Pub. Date: Apr. 18, 2013

(54) LIQUID CRYSTAL DISPLAY DEVICE

(71) Applicants: Noriyuki KIZU, Ishikawa-ken (JP); Jin HIROSAWA, Saitama-ken (JP)

(72) Inventors: Noriyuki KIZU, Ishikawa-ken (JP); Jin HIROSAWA, Saitama-ken (JP)

(73) Assignee: Japan Display Central Inc., Saitama (JP)

(21) Appl. No.: 13/602,629

(22) Filed: Sep. 4, 2012

(30) Foreign Application Priority Data
Oct. 17, 2011 (JP) 2011-227767

(51) Int. Cl. G02F 1/1343; G02F 1/1335

(52) U.S. Cl. 349/96; 349/106

(57) ABSTRACT

In one embodiment, a first signal line is arranged on a first insulating substrate and extending in a first direction. A second signal line extends in a second direction orthogonally crossing the first direction. A first electrode is formed between the second signal lines extending in the second direction on the first insulating substrate. A color filter layer is formed on a second insulating substrate facing the first substrate. A second electrode is formed of opaque wiring material on the color filter layer facing the first insulating substrate and extending in the second direction on the both sides sandwiching the first electrode. An edge of the color filter layer is located above the second signal line.

### CROSS-REFERENCE TO RELATED APPLICATION

This application is based upon and claims the benefit of priority from prior Japanese Patent Application No. 2011-227767, filed Oct. 17, 2011, the entire contents of which are incorporated herein by reference.

### FIELD

Embodiments described herein relate generally to a liquid crystal display device.

### BACKGROUND

In recent years, a flat panel display is developed briskly. Especially, the liquid crystal display device gets a lot of attention from advantages, such as light weight, thin shape, and low power consumption. In an active matrix type liquid crystal display device equipped with a switching element in each pixel, a structure using lateral electric field, such as IPS (In-Plane Switching) mode and FFS (Fringe Field Switching) mode, attracts attention. The liquid crystal display device using the lateral electric field mode is equipped with pixel electrodes and a common electrode formed in an array substrate, respectively. Liquid crystal molecules are switched by the lateral electric field substantially in parallel with the principal surface of the array substrate.

On the other hand, another technique is also proposed, in which the liquid crystal molecules are switched using the lateral electric field or an oblique electric field between the pixel electrode formed in the array substrate and the common electrode formed in a counter substrate.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a figure schematically showing a structure and the equivalent circuit of a liquid crystal display device according to a first embodiment.

FIG. 2A is a plan view schematically showing a structure of one pixel when the liquid crystal display panel shown in FIG. 1 is seen from the counter substrate side.

FIGS. 2B and 2C show the relationship between a polarization axis and an initial alignment direction.

FIG. 3 is a cross-sectional view schematically showing the structure taken along line A-A in the liquid crystal display panel shown in FIG. 2A according to a first embodiment.

FIG. 4 is a cross-sectional view schematically showing the structure taken along line A-A in the liquid crystal display panel shown in FIG. 2A according to a second embodiment.

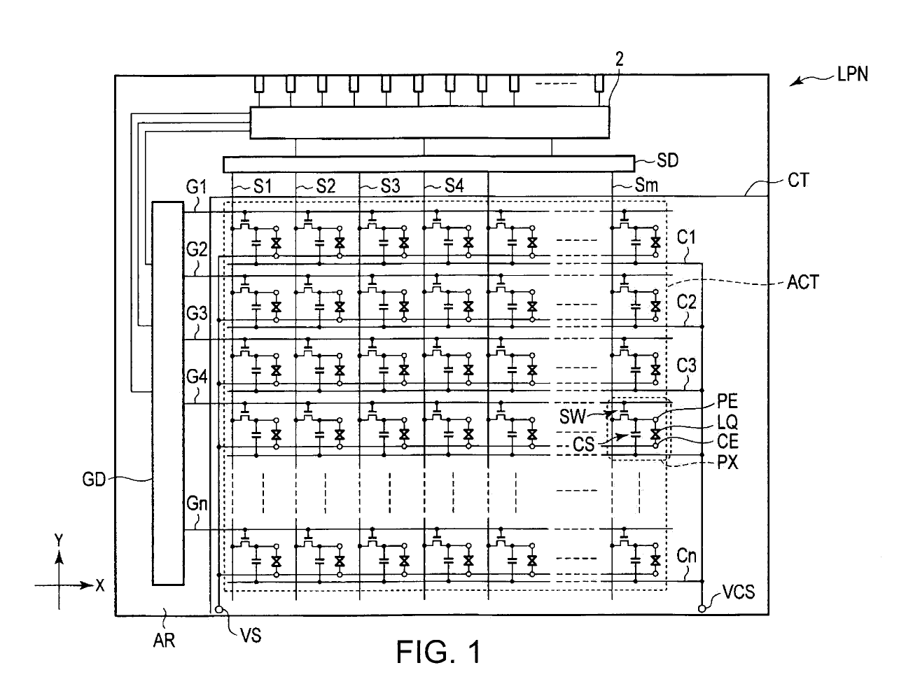

### DETAILED DESCRIPTION

A liquid crystal display device according to an exemplary embodiment of the present invention will now be described with reference to the accompanying drawings wherein the same or like reference numerals designate the same or corresponding parts throughout the several views.

According one embodiment, a liquid crystal display device includes: a first substrate including a first insulating substrate, a first signal line arranged extending in a first direction, a second signal line extending in a second direction orthogonally crossing the first direction, and a first electrode extending in the second direction, the first and second signal lines and the first electrode being arranged on the first insulating substrate; a second substrate including a second insulating substrate, a color filter layer formed on the second insulating substrate facing the first substrate, and a second electrode formed of opaque wiring material on the color filter layer facing the first substrate and extending in the second direction on the both sides sandwiching the first electrode, wherein an edge of the color filter layer is located above the second signal line; and a liquid crystal layer held between the first substrate and the second substrate and having liquid crystal molecules.

The liquid crystal display device includes an active matrix type liquid crystal display panel LPN. The liquid crystal display panel LPN is equipped with an array substrate AR as a first substrate, a counter substrate arranged facing the array substrate AR as a second substrate, and a liquid crystal layer LQ held between the array substrate AR and the counter substrate CT. The liquid crystal display panel LPN includes an active area ACT which displays images. The active area ACT is constituted by a plurality of pixels arranged in a matrix of (m×n), here, m and n are positive integers.

The liquid crystal display panel LPN is equipped with “n” gate lines G (G1-Gn), “n” auxiliary capacitance lines C (C1-Cn), “m” source lines S (S1-Sm), etc., in the active area ACT. The gate line G and the auxiliary capacitance line C, for example, correspond to signal lines extending in a first direction, respectively. The gate line G and the auxiliary capacitance line C adjoin with a predetermined distance along a second direction Y that orthogonally intersects the first direction X. The source lines S cross the gate line G and the capacitance line C. The source lines S correspond to signal lines extending linearly in the second direction Y, respectively. The gate line G, the auxiliary capacitance line C and the source lines S do not necessarily extend linearly, and a portion thereof may be crooked partially.

Each gate line G is pulled out to outside of the active area ACT and is connected to a gate driver GD. Each source line S is pulled out to the outside of the active area ACT and is connected to a source driver SD. At least a portion of the gate driver GD and the source driver SD is formed in the array substrate AR, for example, and the gate driver GD and the source driver SD are connected with the driver IC chip 2 provided in the array substrate AR and having an implemented controller.

Each pixel PX includes a switching element SW, a pixel electrode PE, a common electrode CE, etc. Retention capacitance Cs is formed, for example, between the auxiliary capacitance line C and the pixel electrode PE. The auxiliary capacitance line C is electrically connected with a voltage impressing portion VCS to which the auxiliary capacitance voltage is impressed.

In addition, in the liquid crystal display panel LPN according to this embodiment, while the pixel electrode PE is formed in the array substrate AR, at least one portion of the common electrode CE is formed in the counter substrate CT. Liquid crystal molecules of the liquid crystal layer LQ are switched mainly using an electric field formed between the pixel electrode PE and the common electrode CE. The electric field formed between the pixel electrode PE and the common electrode CE is an oblique electric field slightly oblique with respect to a X-Y plane specified by the first direction X and second direction Y, i.e., the principal surface of the substrates, or a lateral electric field substantially in parallel with the principal surface of the substrates.

The switching element SW is constituted by an n channel type thin film transistor (TFT), for example. The switching element SW is electrically connected with the gate line G and the source line S. The switching element SW may be either a top-gate type or a bottom-gate type. Though the semiconductor layer is formed of poly-silicon, the semiconductor layer may be formed of amorphous silicon.

The pixel electrode PE is arranged in each pixel PX and electrically connected with the switching element SW. The common electrode CE is commonly arranged to the pixel electrodes PE of the plurality of pixels PX through the liquid crystal layer LQ.

According to this embodiment, the common electrode CE is formed of wiring material, opaque conductive material, or conductive materials having light shield or reflective characteristics. The common electrode CE is formed of at least one of metal materials of a group consisting of aluminum (Al), titanium (Ti), silver (Ag), molybdenum (Mo), tungsten (W), copper (Cu), and chromium (Cr), or metal alloy including at least one of metal materials of the group.

The pixel electrode PE may be formed by light transmissive conductive materials, such as Indium Tin Oxide (ITO) and Indium Zinc Oxide (IZO), etc., or may be formed of above wiring materials.

The transmissivity of the common electrode CE formed using the above-mentioned wiring material is lower than that of the electrode formed of transparent electric conductive materials, such as ITO, for example, the transmissivity is 1% or less. Moreover, sheet resistance of the common electrode CE formed using the above-mentioned wiring material is lower than that of the electrode formed of transparent electric conductive material. While the sheet resistance of the ITO electrode of 100 nm film thickness is about Ω/□ to as an example, the sheet resistance of the molybdenum tungsten (MoW) electrode of 100 nm film thickness is about 2Ω/□, and the sheet resistance of a laminated electrode of the aluminum titanium aluminum (Al/Ti/Al) of 100 nm film thickness is about 0.5Ω/□.

The array substrate AR includes an electric power supply portion VS to supply a common voltage to the common electrode CE. The common electrode CE is formed outside of the active area ACT. Furthermore, the common electrode CE is drawn to outside of the active area ACT and electrically connected with the electric power supply portion VS formed in the array substrate AR through an electric conductive component which is not illustrated.

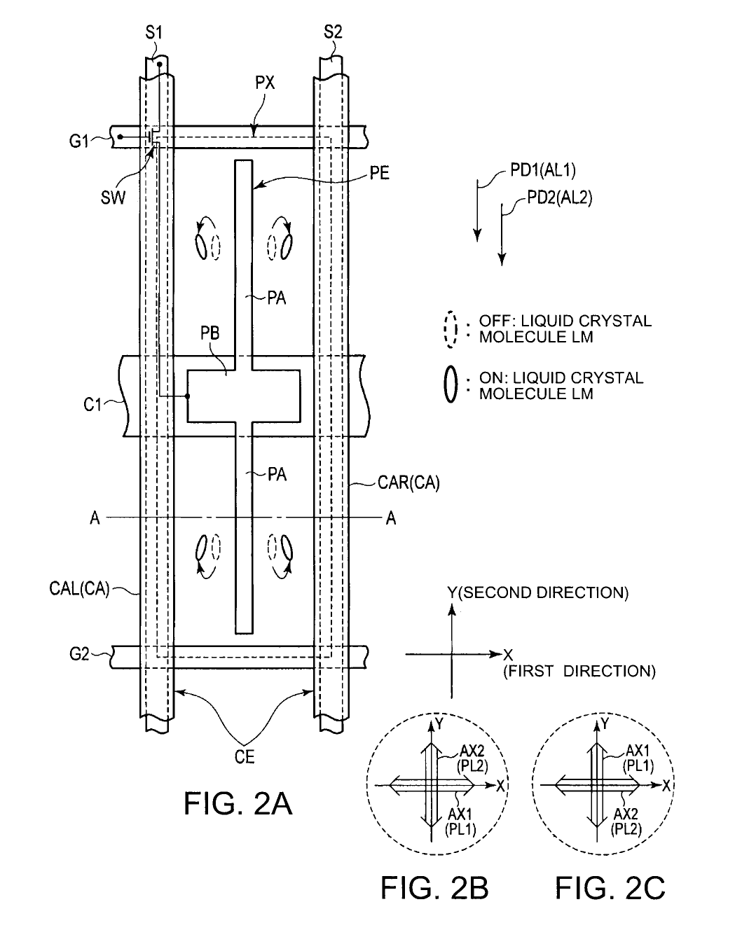

FIG. 2A is a plan view schematically showing the structure of one pixel when the liquid crystal display panel according to one embodiment is seen from the counter substrate side. Herein, a plan view in a X-Y plane specified in the first direction X and the second direction Y is shown.

The array substrate AR is equipped with a gate line G1, a gate line G2, an auxiliary capacitance line C1, a source line S1, a source line S2, a switching element SW, a pixel electrode PE, and a first alignment film AL1, etc. In the illustrated example, the counter substrate CT is equipped with a common electrode CE and a second alignment film AL2.

In the figure, the pixel PX has the shape of a rectangle whose length in the first direction X is shorter than the length in the second direction Y, as shown in a dashed line. The gate line G1 and the gate line G2 are arranged with a first pitch along the second direction Y and extend along the first direction X, respectively. The auxiliary capacitance line C1 is arranged between the gate line G1 and the gate line G2 and extends in the first direction X. The source line S1 and the source line S2 are arranged with a second pitch therebetween in the first direction X and extend along the second direction Y, respectively.

In the illustrated pixel PX, the source line S1 is arranged at the left-hand side end in the pixel PX. Precisely, the source line S1 is arranged striding over a boundary between the illustrated pixel PX and a pixel PX adjoining the illustrated pixel PX on the left-hand side. The source line S2 is arranged at the right-hand side end. Precisely, the source line S2 is arranged striding over a boundary between the illustrated pixel PX and a pixel PX adjoining the illustrated pixel PX on the right-hand side. Moreover, in the pixel PX, the gate line G1 is arranged at an upper end portion. Precisely, the gate line G1 is arranged striding over a boundary between the illustrated pixel PX and a pixel PX adjoining the illustrated pixel PX on its upper end side. The gate line G2 is arranged at a lower end portion. Precisely, the gate line G2 is arranged striding over a boundary between the illustrated pixel PX and a pixel adjoining the illustrated pixel PX on its lower end side.

The switching element SW is electrically connected with the gate line G1 and the source line S1 in the illustrated example. The pixel electrode PE is connected with the switching element SW. The pixel electrode PE is arranged between the adjoining source line S1 and the source line S2. Moreover, the pixel electrode PE is located between the gate line G1 and the gate line G2.

The pixel electrode PE is equipped with a main pixel electrode PA and a sub-pixel electrode PB electrically connected mutually. The main pixel electrode PA linearly extends along the second direction Y. The main pixel electrode PA is formed in the shape of a belt having the substantially same width in the first direction X. The sub-pixel electrode PB linearly extends along the first direction X. The sub-pixel electrode PB is located at an overlapped portion with the auxiliary capacitance line C1. The sub-pixel electrode PB is formed in the shape of a belt having the substantially same width in the second direction Y. In this embodiment, the pixel electrode PE includes one main pixel electrode PA. The main pixel electrode PA is located substantially in a middle portion between the source line S1 and the source line S2. The distance between the source line S1 and the main pixel electrode PA along the first direction X is substantially the same as that between the source line S2 and the main pixel electrode PA along the first direction.

In the array substrate AR, the pixel electrode PE is covered with a first alignment film AL1 Alignment treatment (for example, rubbing processing or optical alignment processing) is made to this first alignment film AL1 along a first alignment treatment direction PD1 to initially align the liquid crystal molecule of the liquid crystal layer LQ. The first alignment treatment direction PD1 is substantially in parallel with the second direction Y.

The common electrode CE is equipped with a main common electrode CAL and a main common electrode CAR. The main common electrode CAL and the main common electrode CAR extend along the second direction Y substantially in parallel with an extending direction of the main pixel electrode PA on the both sides which sandwich the main pixel electrode PA in the X-Y plane. The main common electrode CAL counters with the source line S1, and the main common electrode CAR counters with the source line S2. The main common electrode CAL and the main common electrode CAR are formed in the shape of a belt having substantially same width along the first direction X. In the active area or outside of the active area, the main common electrodes CAL and the main common electrode CAR are electrically connected each other.

In the illustrated pixel PX, the main common electrode CAL is arranged on the left-hand side, and the main common electrode CAR is arranged on the right-hand side. Precisely, the main common electrode CAL is arranged striding over a boundary between the illustrated pixel PX and an adjoining pixel PX on its left-hand side. The main common electrode CAR is arranged striding over a boundary between the illustrated pixel PX and an adjoining pixel PX on its right-hand side.

If its attention is paid to the positional relationship between the pixel electrode PE and the common electrode CE, the pixel electrode PE does not overlap with the common electrode CE, and forms a penetration region therebetween capable of penetrating light. The main pixel electrode PA is arranged in parallel with the respective extending directions of the main common electrode CAL and the main common electrode CAR (second direction Y). Penetration regions are formed, respectively, between the main pixel electrode PA and the main common electrode CAL and between the main pixel electrode PA and the main common electrode CAR. In the X-Y plane, the inter-electrode distance in the first direction X between the main common electrode CAL and the main pixel electrode PA is the same in the inter-electrode distance between the main common electrode CAR and the main pixel electrode PA in the first direction X.

In the counter substrate CT, the common electrode CE is covered with a second alignment film AL2. Alignment treatment (for example, rubbing processing or optical alignment processing) is made to the second alignment film AL2 along a second alignment treatment direction PD2 to initially align the liquid crystal molecule of the liquid crystal layer LQ. The second alignment treatment direction PD2 is substantially in parallel with the first alignment treatment direction PD1 and the same direction or opposite direction each other. In the example shown in the figure, the second alignment treatment direction PD2 is substantially in parallel with the second direction Y. In the X-Y plane, the second alignment treatment direction PD2 is in parallel with and the same direction as the first alignment treatment direction PD1.

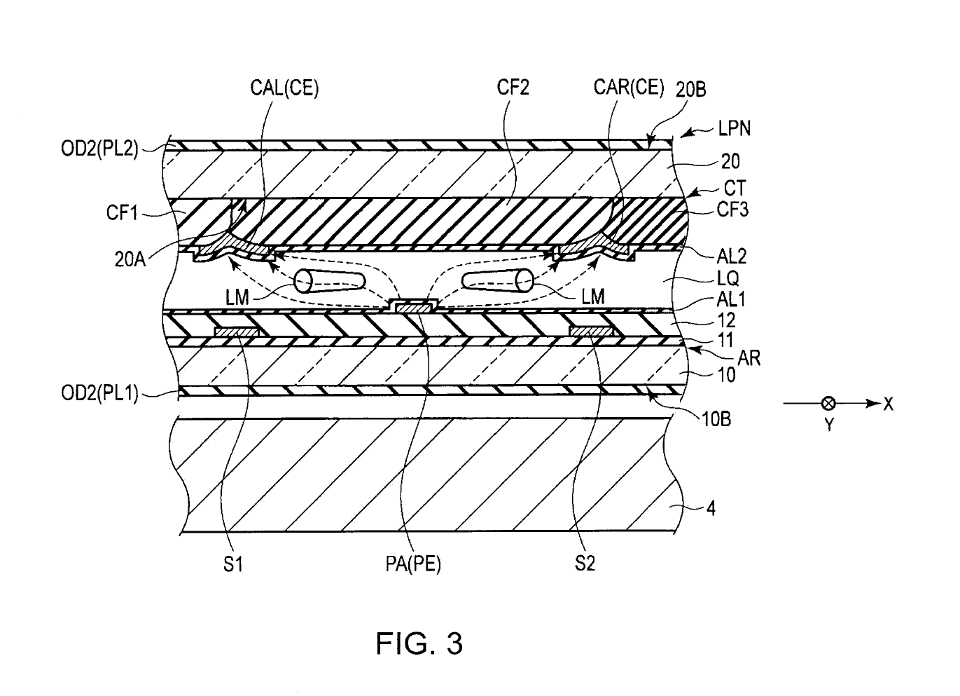

FIG. 3 is a cross-sectional view schematically showing the structure taken along line A-A in the liquid crystal display panel LPN shown in FIG. 2A according to a first embodiment. In addition, the figure shows only a portion necessary to be explained.

A backlight 4 is arranged on the back side of the array substrate AR in the illustrated example. Various types of backlights 4 can be used. For example, a light emitting diode (LED) or a cold cathode fluorescent lamp (CCFL), etc., can be applied as a light source of the backlight 4, and the explanation about its detailed structure is omitted.

The array substrate AR is formed using a first transmissive insulating substrate 10. The array substrate AR includes the source line S1, the source line S2, the pixel electrode PE including the main pixel electrode PA, a first insulating film 11, a second insulating film 12, and the first alignment film AL1 etc., in the inner side of the first insulating substrate 10, i.e., facing the counter substrate CT. The array substrate AR includes the gate line, the auxiliary capacitance line and switching element which are not illustrated.

The source line S1 and the source line S2 are formed on the first insulating film 11, and are covered with the second insulating film 12. In addition, the gate line and the auxiliary capacitance line which are not illustrated are arranged between the first insulating substrate 10 and the first insulating film 11, for example. The pixel electrode PE containing the main pixel electrode PA is formed on the second insulating film 12. The main pixel electrode PA is located in the inner side of the pixel PX rather than the positions right on the source line S1 and the source line S2.

The first alignment film AL1 is arranged on the array substrate AR facing the counter substrate CT, and extends to whole active area ACT. The first alignment film AL1 covers the pixel electrode PE including the main pixel electrode PA and the second insulating film 12. The first alignment film AL1 is formed of the material which shows a horizontal alignment characteristics.

The array substrate AR may include a portion of the common electrode CE.

The counter substrate CT is formed using a second insulating substrate 20 which has a transmissive characteristics. The counter substrate CT includes, color filters CF1-CF3, the common electrode including the main common electrodes CAL and CAR, and the second alignment film AL2, etc., in the internal surface of the second insulating substrate 20 facing the array substrate AR.

The color filters CF1 to CF3 are formed in the internal surface 20A of the second insulating substrate 20 facing the array substrate AR. Each of the color filters CF1 to CF3 extends in the second direction Y and is arranged so as to correspond to each pixel arranged in adjoining in the first direction X. The colors of the color filters CF1 to CF3 arranged in the adjoining pixels PX in the first direction X differ mutually. For example, the color filters CF1-CF3 are formed of resin materials colored by three primary colors of red, green, and blue, respectively. The color filter CF1 formed of resin material colored in red is a red color filter and arranged corresponding to a red pixel. The color filter CF2 formed of resin material colored in green is a green color filter and arranged corresponding to a green pixel. The color filter CF3 formed of resin material colored in blue is a blue color filter and arranged corresponding to a blue pixel. The boundary between the adjoining color filters is located above the source line S. That is, in the example shown in the figure, an edge of the color filter CF1 and an edge of the color filter CF2 are arranged right above the source line S1, and an edge of the color filter CF2 and an edge of the color filter CF3 are arranged right above the source line S2.

The main common electrode CAL and the main common electrode CAR of the common electrode CE are formed in the inside of the color filters CF1-CF3, facing the array substrate AR. The main common electrode CAL is located right above the source line S1, and overlaps with the edge of color filter CF1 and the edge of color filter CF2. Namely, the main common electrode CAL covers a step of the boundary between the color filter CF1 and the color filter CF2. The main common electrode CAR is located right above the source line S2, and overlaps with the edge of color filter CF2, and the edge of color filter CF3. That is, the main common electrode CAR covers the step of the boundary between the color filter CF2 and the color filter CF3. The regions between the main common electrode CAL and the main pixel electrode PA, and between the main common electrode CAR and the main pixel electrode PA correspond to the penetration regions in which the light can penetrate.

The second alignment film AL2 is arranged on the counter substrate CT facing the array substrate AR, and extends to whole active area ACT. The second alignment film AL2 covers the common electrode CE including the main common electrode CAL and the main common electrode CAR, and the color filters CF1 to CF3. The second alignment film AL2 is formed of the materials having horizontal alignment characteristic.

The array substrate AR and the counter substrate CT as mentioned-above are arranged so that the first alignment film AL1 and the second alignment film AL2 face each other. In this case, a pillar-shaped spacer is formed integrally with one of the substrates by resin material between the first alignment film AL1 on the array substrate AR and the second alignment film AL2 on the counter substrate CT. Thereby, a predetermined gap, for example, a 2-7 μm cell gap, is formed, for example. The array substrate AR and the counter substrate CT are pasted together by seal material which is not illustrated, in which the predetermined cell gap is formed, for example.

The liquid crystal layer LQ is held at the cell gap formed between the array substrate AR and the counter substrate CT, and is arranged between the first alignment film AL1 and the second alignment film AL2. The liquid crystal layer LQ contains the liquid crystal molecule which is not illustrated. The liquid crystal layer LQ is constituted, for example, by positive type liquid crystal material.

In addition, the distances between the main pixel electrode PA and the main common electrode CAL and between the main pixel electrode PA and the main common electrode CAR in the first direction X are larger more than twice than the thickness of the liquid crystal layer LQ, respectively.

A first optical element OD1 is attached on an external surface 10B of the array substrate AR, i.e., the external surface of the first insulating substrate 10 which constitutes the array substrate AR, by adhesives, etc. The first optical element OD1 is located on a side which counters with the backlight unit 4 of the liquid crystal display panel LPN, and controls the polarization state of the incident light which enters into the liquid crystal display panel LPN from the backlight unit 4. The first optical element OD1 includes a first polarizing plate PL1 having a first absorption axis AX1. Other optical elements such as retardation film may be arranged between the first polarizing plate PL1 and the first insulating substrate 10.

A second optical element OD2 is attached on an external surface 20B of the counter substrate CT, i.e., the external surface of the second insulating substrate 20 which constitutes the counter substrate CT, by adhesives, etc. The second optical element OD2 is located on a display surface side of the liquid crystal display panel LPN, and controls the polarization state of emitted light from the liquid crystal display panel LPN. The second optical element OD2 includes a second polarizing plate PL2 having a second absorption axis AX2. Other optical elements such as retardation film may be arranged between the second polarizing plate PL2 and the second insulating substrate 20.

The first absorption axis AX1 of the first polarizing plate PL1 and the second absorption axis AX2 of the second polarizing plate PL2 are arranged in the Cross Nicol state in which they substantially intersects perpendicularly. At this time, one polarizing plate is arranged, for example so that its absorption axis is arranged substantially in parallel with or in orthogonal with the extending direction (second direction Y) of the pixel electrode PA or the main common electrode CA. That is, one of the polarizing plate is arranged so that the absorption axis of the polarizing plate is arranged substantially in parallel with or orthogonally crossing the initial alignment direction (second direction Y) i.e., the first alignment treatment direction PD1 or the second alignment treatment direction PD2.

In one example shown in FIG. 2B, the second polarizing plate PL2 is arranged so that the second absorption axis AX2 is arranged in parallel with the second direction Y, and the first polarizing plate PL1 is arranged so that the first absorption axis AX1 is arranged in parallel with the first direction X. In FIG. 2C, the first polarizing plate PL1 is arranged so that the first absorption axis AX1 is arranged in parallel with the second direction Y, and the second polarizing plate PL2 is arranged so that the second absorption axis AX2 is arranged in parallel with the first direction X.

Next, the operation of the liquid crystal display panel LPN of the above-mentioned structure is explained referring to FIGS. 2A, 2B and 2C and FIG. 3.

when a voltage is not impressed to the liquid crystal layer LQ, i.e., when an electrical field is not formed between the pixel electrode PE and the common electrode CE (OFF time), the liquid crystal molecules LM of the liquid crystal layer LQ are aligned so that their long axis are aligned in parallel with the first alignment treatment direction PD1 of the first alignment film AL1 and the second alignment treatment direction PD2 of the second alignment film AL2 as shown with a dashed line in the figure. In this state, the time of OFF corresponds to the initial alignment state, and the alignment direction of the liquid crystal molecule LM at the time OFF corresponds to the initial alignment direction.

In addition, precisely, the liquid crystal molecules LM are not exclusively aligned in parallel with the X-Y plane, but are pre-tilted in many cases. For this reason, herein, the direction of the initial alignment of the liquid crystal molecule LM is a direction in which an orthogonal projection of the long axis of the liquid crystal molecule LM at the time of OFF is carried out to the X-Y plane. Hereinafter, the explanation is simply made under presumption that the liquid crystal molecule LM aligns in parallel with the X-Y plane and rotates in parallel with the X-Y plane. Here, both of the first alignment treatment direction PD1 of the first alignment film AL1 and the second alignment treatment direction PD2 of the second alignment film AL2 are directions in parallel to the second direction Y. At the time of OFF, the long axis of the liquid crystal molecule LM is initially aligned substantially in parallel to the second direction Y as shown in a dashed line in FIG. 2A.

In the cross-section of the liquid crystal layer LQ, in case the first alignment treatment direction PD1 and the second alignment treatment direction PD2 are in parallel and the same each other, the liquid crystal molecule LM is aligned substantially in horizontal (pre-tilt angle is substantially zero) near the intermediate portion of the liquid crystal layer LQ. The liquid crystal molecule LM is aligned with the pre-tilt angle which becomes symmetrical with respect to the intermediate portion in a portion near the first alignment film AL1 and a portion near the second alignment film AL2. That is, the liquid crystal molecule LM is aligned in a splay alignment state. In the splay alignment state, even if a viewing angle is an inclined direction from a normal line direction of the substrate, the viewing angle is optically compensated by the liquid crystal molecules LM near the first alignment film AL1 and the second alignment film AL2. Therefore, when the first alignment treatment direction PD1 are in parallel with and the same as the second alignment treatment direction PD2, in a black display, there are few optical leaks. Accordingly, a high contrast ratio can be realized, and it becomes possible to improve display grace.

In addition, when the first alignment treatment direction PD1 and the second alignment treatment direction PD2 are in parallel and opposite each other in the cross section of the liquid crystal layer LQ, the liquid crystal molecule LM aligns with a uniform pre-tilt angle in the intermediate portion of the liquid crystal layer LQ, near the first alignment film AL1, and near the second alignment film AL2 (homogeneous alignment).

A portion of the backlight from the backlight 4 penetrates the first polarizing plate PL1, and enters into the liquid crystal display panel LPN. The light which entered into the liquid crystal display panel LPN is linearly polarized light which intersects perpendicularly with the first absorption axis AX1 of the first polarizing plate PL1. However, at the time of OFF, the polarization state of the linearly polarized light which passes the liquid crystal layer LQ hardly changes. For this reason, the linearly polarized light which penetrates the liquid crystal display panel LPN is absorbed by the second polarizing plate PL2 which is arranged in Cross Nicol positional relationship with the first polarizing plate PL1 (black display).

On the other hand, in case a voltage is impressed to the liquid crystal layer LQ, i.e., the electric field is formed between the pixel electrode PE and the common electrode CE (at the time of ON), the lateral electric field (or oblique electric field) is formed in parallel with the substrates between the pixel electrode PE and the common electrode CE as shown in FIG. 3 The liquid crystal molecule LM is affected by the electric field between the pixel electrode PE and the common electrode CE, and its long axis rotates along the electric flux line shown in FIG. 3. In addition, the liquid crystal molecule LM rotates so that its long axis is substantially in parallel with the X-Y plane as shown in a solid line in FIG. 2A.

In the example shown in FIG. 2A, in a region at the lower left of the pixel PX, the liquid crystal molecule LM aligns so that the liquid crystal molecule LM rotates clockwise to the second direction Y and turns to the lower left in the figure. In a region at the upper left of the pixel PX, the liquid crystal molecule LM aligns so that the liquid crystal molecule LM rotates counterclockwise to the second direction Y and turns to the upper left in the figure. In a region at the lower right of the pixel PX, the liquid crystal molecule LM aligns so that the liquid crystal molecule LM rotates counterclockwise to the second direction Y and turns to the lower right in the figure. In a region at the upper right of the pixel PX, the liquid crystal molecule LM aligns so that the liquid crystal molecule LM rotates clockwise to the second direction Y and turns to the upper right in the figure.

Thus, in each pixel PX, in case electric field is formed between the pixel electrode PE and the common electrode CE, the alignment direction of the liquid crystal molecule LM is divided in two or more directions by the position which overlaps with the pixel electrode PE or the common electrode CE, and domains are formed in each alignment direction. That is, two or more domains are formed in one pixel PX.

At the time of ON, linearly polarized light which intersects perpendicularly with the first absorption-axis AX1 of the first polarizing plate PL1 enters into the liquid crystal display panel LPN. The polarization state of the linearly polarized light changes in accordance with the alignment state of the liquid crystal molecule LM when passing the liquid crystal layer LQ. For example, if the linearly polarized light in parallel to the first direction X enters into the liquid crystal display panel LPN in the X-Y plane, when passing the liquid crystal layer LQ, the light receives influence of phase difference by λ/2 by the liquid crystal molecule LM which is aligned in a 45°-225° direction or a 135°-315° direction with respect to the first direction X (herein, λ is a wavelength of the light which penetrates the liquid crystal layer LQ). Thereby, the polarization state of the light which passes the liquid crystal layer LQ becomes linearly polarized light in parallel to the second direction Y. For this reason, at the time of ON, at least a portion of the light which passes the liquid crystal layer LQ penetrates the second polarizing plate PL2 (white display). However, in the position which overlaps with the pixel electrode or the common electrode, since the liquid crystal molecule maintains the initial alignment state, it becomes a black display like the time of OFF.

By the way, in the structure in which the black matrix is arranged between the adjoining pixels, there is a possibility that the alignment of the liquid crystal molecule may be also disordered due to the disturbance of electric field near the boundary between adjoining pixels because the step of the black matrix influences to the liquid crystal molecule. In this case, there is a possibility that a bright may be generated at the time of ON because the liquid crystal molecule near the boundary of adjoining pixels can not maintain the initial alignment state. Moreover, when the rubbing processing is applied to the second alignment film AL2 as the alignment treatment, insufficient rubbing may be resulted near the boundary between the adjoining pixels by the influence of the step of the black matrix. Therefore, the light leakage in black state may be generated because the alignment state of the liquid crystal molecule is not specified in the initial alignment state under the influence of the step of the black matrix.

Then, according to this embodiment, a black matrix is not arranged on the boundary between the adjoining pixels, but each edge of the color filters CF1-CF3 is located in the inside surface 20A of the second insulating substrate 20. For this reason, it becomes possible to make the step small near the boundary between the adjoining pixels. According to this embodiment, the main common electrode CA located in the boundary between the adjoining pixels is formed using an opaque wiring material. For this reason, when small step is formed in the boundary between the color filters, even if the alignment state of the liquid crystal molecule LM is disordered under the influence of the step, it becomes possible to control generating of the light leakage in black state by the main common electrode CA. By the above structure, it becomes possible to control reduction of a contrast ratio. Moreover, since the black matrix can be eliminated, it becomes possible to lower manufacturing cost.

Moreover, according to this embodiment, the common electrode CE is formed of wiring material which does not use indium (In). For this reason, as compared with the case where the both of the pixel electrode PE and the common electrode CE are formed of ITO or IZO, it becomes possible to reduce the amount of the used indium. Moreover, when not only the common electrode CE but the pixel electrode PE are formed of the electric conductive material which does not use the indium (In), it becomes possible to realize an indium free display device.

Moreover, according to this embodiment, if the common electrode CE is formed of black electric conductive material, it is possible to control reflection by the outside light which enters into the display surface, and it also becomes possible to improve display grace.

Moreover, according to this embodiment, the first absorption axis AX1 of the first polarizing plate PL1 located on the backlight side of the liquid crystal display panel LPN is arranged approximately in parallel with the second direction Y that is an extending direction of the main common electrode CA, or so as to orthogonally cross the second direction Y. That is, the linearly polarized light which entered into the liquid crystal display panel LPN is in parallel with or perpendicularly intersects the extending direction of the edge of the common electrode CE formed of the opaque electric material. Moreover, the extending directions of the gate line G, the auxiliary capacitance line C, and the source line S, respectively, formed of the above opaque electric conductive material is substantially in parallel with or perpendicularly intersects the linearly polarized light which entered into the liquid crystal panel LPN. Furthermore, the pixel electrode PE may be also formed the above opaque electrical conductive materials. In this case, the extending direction of the pixel electrode PA is substantially in parallel with or intersects perpendicularly the linearly polarized light which entered into the liquid crystal panel LPN. For this reason, the polarized face of the reflected light by the edges of the common electrode CE, the gate line G, the auxiliary capacitance line C, and the source line S is not disturbed easily. Accordingly, in the lineally polarized light which passed the first polarizing plate PL1 at the time OFF, the polarized face can be maintained without being disturbed when passing the liquid crystal panel LPN, and is fully absorbed by the second polarizing plate PL2. Therefore, it becomes possible to control the optical leak. That is, transmissivity (black luminosity) can be fully reduced in the black display, and it becomes possible to control the fall of the contrast ratio. Moreover, it is not necessary to make the width of the black matrix BM large for the measure against the optical leak in the circumference of the common electrode CE. Accordingly, it becomes possible to control reduction of the transmissive area and the transmissivity at the time of ON, and consequently the decrease of the display grace.

Moreover, according to this embodiment, it becomes possible to obtain high transmissivity in the electrode gap between the pixel electrode PE and the common electrode CE, and correspond by expanding the inter-electrode distance between the pixel electrode PE and the main common electrode CA in order to make transmissivity of each pixel high enough. Further, in the product specifications in which a pixel pitch differs each other, a transmissivity distribution peak can be used by changing the inter-electrode distance. That is, in the display mode according to this embodiment, it becomes possible to offer the display panel having various pixel pitches by setting up inter-electrode distance without necessarily using microscopic processing corresponding to the product specification from low resolution with a comparatively large pixel pitch to high resolution with a comparatively small pixel pitch.

Moreover, according to this embodiment, in a region which overlaps with the black matrix BM, the transmissivity fully falls. This is because the leak of electric field does not occur outside of the pixel from the common electrode CE arranged on the gate line G and the source line S, and undesired lateral electric field is not produced between the adjoining pixels. That is, it is because the liquid crystal molecule which overlaps with the common electrode CE maintains the initial alignment state like at the time OFF (or the time of the black display). That is, when the pixel PX is seen in the X-Y plane, since the pixel electrode PE arranged on the array substrate AR is located between the pair of common electrodes CE formed on the counter substrate CT, the electric flux line has a starting point and a terminal point in one pixel, and the flux line does not leak to adjoining pixels. Therefore, the electric field impressed to the liquid crystal layer LQ does not receive influence between the adjoining pixels PX in the first direction X. Accordingly, the liquid crystal molecule LM of one pixel PX does not rotate by the influence from the adjoining pixel PX, and it is possible to suppress the degradation of display grace. Furthermore, even if it is a case where the colors of the color filter differ between the adjoining pixels, it becomes possible to control the generating of mixed colors, and also becomes possible to control the fall of color reproducibility and the contrast ratio.

Moreover, according to this embodiment, it becomes possible to form two or more domains in one pixel. For this reason, a viewing angle can be optically compensated in two or more directions, and wide viewing angle is attained.

In addition, although the above-mentioned example is explained about the case where the initial alignment direction of the liquid crystal molecule LM is in parallel to the second direction Y, the initial alignment direction of the liquid crystal molecule LM may be an oblique direction which obliquely crosses the first direction X and the second direction Y.

Moreover, although in the above case, the liquid crystal layer LQ is constituted by the liquid crystal material which has positive dielectric constant anisotropy (positive type), the liquid crystal layer LQ may be constituted by the liquid crystal material which has negative dielectric constant anisotropy (negative type).

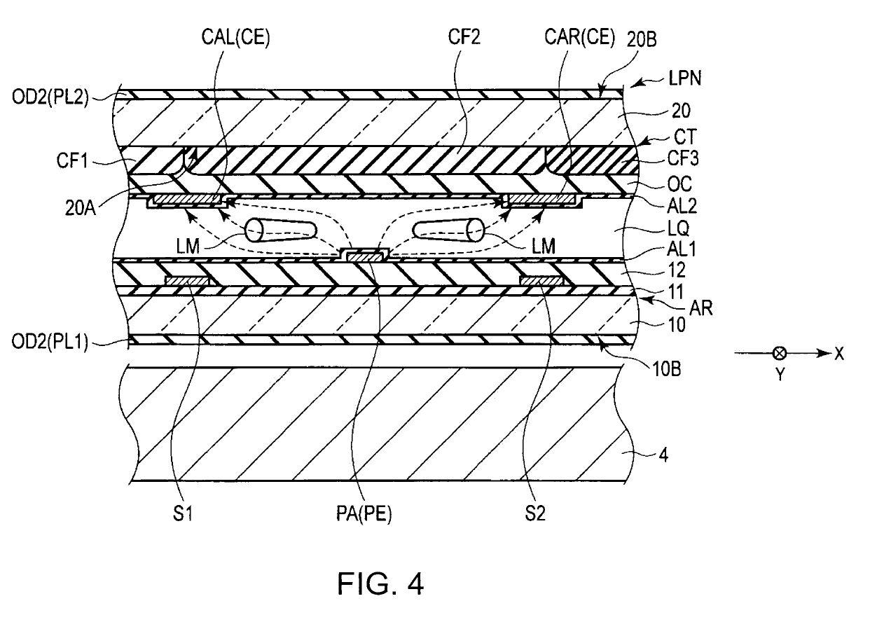

FIG. 4 is a cross-sectional view schematically showing other structure according to a second embodiment taken along line A-A of the liquid crystal display panel LPN shown in FIG. 2A. In addition, only the portions required for explanation are illustrated here.

This embodiment is different from the first embodiment shown in FIG. 3 in that the counter substrate CT is equipped with an overcoat layer OC arranged between the color filters CF1-CF3 and the common electrode CE.

That is, the overcoat layer OC covers a surface of the color filters CF1-CF3 facing the array substrate AR. This overcoat layer OC is formed of a transparent resin material, and makes easy unevenness of the surface of the color filters CF1-CF3, especially, the step of the boundary portion between the adjoining color filters.

The main common electrode CAL and the main common electrode CAR of the common electrode CE are formed in the inside surface of the overcoat layer OC facing the array substrate AR. The main common electrode CAL is located above the source line S1, and under the edges of color filter CF1 and the color filter CF2. The main common electrode CAR is located above the source line S2, and under the edges of the color filter CF2 and the color filter CF3. Both the overcoat layer OC and common electrode CE are covered with the second alignment film AL2.

Also in this embodiment, the same effect as the first embodiment is acquired. In addition, it becomes possible to smooth more a ground surface on which the common electrode CE is formed by arranging the overcoat layer OC between the color filters CF1-CF3 and the common electrode CE. For this reason, it becomes possible to ease the step in the boundary between the adjoining color filters more and control more effectively the generation of the light leakage in black state resulted by the alignment disorder of the liquid crystal molecule LM.

Next, among the first embodiment shown in FIG. 3, the second embodiment shown in FIG. 4, and a comparative example, the contrast ratio and the black luminosity are compared.

As a comparative example, the liquid crystal display panel LPN of the same structure as that shown in FIG. 4 is used except that the black matrix is arranged on the boundary between the adjoining color filters in the inside 20A of the second insulating substrate 20, and that the common electrode CE is formed of ITO. In addition, the contrast ratio and the black luminosity which were measured are made into relative values with respect to the measured value of the comparative example.

When the contrast ratio of the comparative example is set to 1, the contrast ratio of the first embodiment shown in FIG. 3 became 1.3, the contrast ratio of the second embodiment shown in FIG. 4 became 1.5, and it was checked that a high contrast ratio can be obtained in both embodiments.

When the black luminosity of the comparative example was set to 1, the black luminosity of the first embodiment shown in FIG. 3 was set to 0.75, the black luminosity of the second embodiment shown in FIG. 4 was set to 0.67, and it was checked that black luminosity can be fully reduced in both embodiments.

In addition, according to the embodiments, the structure of the pixel PX is not limited to the above-mentioned example.

Although, in the above embodiment, the case where the main pixel electrode PA and the main common electrode CA extend in the second direction Y, the main pixel electrode PA and the main common electrode CA may extend along the first direction X.

Although, in the above embodiments, the case where the signal line extending along the first direction X is the gate line G, and the signal line extending along the second direction Y is the source line S, the signal line extending along the second direction Y may be the gate line G, and the signal line extending along the first direction X may be the source line S.

Although, in the above embodiments, the case where the pixel electrode PE includes the main pixel electrode PA as the first electrode, and the common electrode CE includes the main common electrode CA as the second electrode located in the both sides which sandwich the first electrode. However, the common electrode CE including the main common electrode CA may be used as the first electrode, and the pixel electrode PE including the main pixel electrode PA sandwiching the first electrode may be also used as the second electrode.

In the above embodiments, although the common electrode CE is equipped with the main common electrode CA in the counter substrate, it is not restricted to the embodiment. For example, in addition to the main common electrode CA, the common electrode CE may include a sub-common electrode that is formed in the counter substrate CT and counters the gate line G and the auxiliary capacity line C. The sub-common electrode extends along the first direction X, and is integrally and continuously formed with the main common electrode CA.

Moreover, the array substrate AR may be equipped with a gate shield electrode which counters the gate line G or a source shield electrode which counters the source line S. The gate shield electrode extends along the first direction X, and is electrically connected with the common electrode CE in the active area or outside of the active area. By providing the gate shield electrode, it is possible to shield undesirable electric field from the gate line G. The source shield electrode extends along the second direction Y, and is electrically connected with the common electrode CE in the active area or outside of the active area. By providing the source shield electrode, it is also possible to shield undesirable electric field from the source line S.

As explained above, according to the embodiments, while reduction of manufacturing cost is possible, it becomes possible to supply the liquid crystal display device which can control degradation of display grace.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device, comprising:
a first substrate including a first insulating substrate, a first signal line arranged extending in a first direction, a second signal line extending in a second direction orthogonally crossing the first direction, and a first electrode extending in the second direction, the first and second signal lines and the first electrode being arranged on the first insulating substrate;
a second substrate including a second insulating substrate, a color filter layer formed on the second insulating substrate facing the first substrate, and a second electrode formed of opaque wiring material on the color filter layer facing the first substrate and extending in the second direction on the both sides sandwiching the first electrode, wherein an edge of the color filter layer is located above the second signal line; and
a liquid crystal layer held between the first substrate and the second substrate and having liquid crystal molecules.

2. The liquid crystal display device according to claim 1, wherein the second electrode overlaps with the edge of the color filter.

3. The liquid crystal display device according to claim 1, wherein the first electrode is formed of a pixel electrode, and the second electrode is formed of a common electrode.

4. The liquid crystal display device according to claim 1, wherein
the second substrate includes an overcoat layer arranged between the color filter layer and the second electrode, and
the second electrode is arranged on the edge of the color filter layer.

5. The liquid crystal display device according to claim 1, wherein the second electrode is arranged above the second signal line.

6. The liquid crystal display device according to claim 1, wherein the second electrode is formed of black conductive material.

7. The liquid crystal display device according to claim 1, wherein the second electrode is formed of at least one of metal materials of a group consisting of aluminum (Al), titanium (Ti), silver (Ag), molybdenum (Mo), tungsten (W), copper (Cu), and chromium (Cr), or metal alloy including at least one of the metal materials of the group.

8. The liquid crystal display device according to claim 1 further comprising a first polarizing plate arranged on an external surface of the first substrate and having a first absorption axis, and a second polarizing plate arranged on an external surface of the second substrate and having a second absorption axis in a Cross Nicol relationship with the first absorption axis, wherein the first absorption axis is substantially in parallel with the first direction or the second direction.

9. A liquid crystal display device, comprising:
a first substrate including a pair of gate lines extending in a first direction, a pair of source lines extending in a second direction orthogonally crossing the first direction, and a pixel electrode arranged between the pair of source lines extending in the second direction;
a second substrate including a color filter layer formed on the second substrate facing the first substrate, a common electrode formed of opaque wiring material on the color filter layer facing the first substrate and extending in the second direction on the both sides sandwiching the pixel electrode, wherein the common electrode is arranged on an edge of the color filter layer; and
a liquid crystal layer held between the first substrate and the second substrate and having liquid crystal molecules.

10. The liquid crystal display device according to claim 9, wherein the second substrate includes an overcoat layer arranged between the color filter layer and the common electrode.

11. The liquid crystal display device according to claim 9, wherein the common electrode is arranged above the source line.

12. The liquid crystal display device according to claim 9, wherein the common electrode is formed of black conductive material.

13. The liquid crystal display device according to claim 9, wherein the second electrode is formed of at least one of metal materials of a group consisting of aluminum (Al), titanium (Ti), silver (Ag), molybdenum (Mo), tungsten (W), copper (Cu), and chromium (Cr), or metal alloy including at least one of the metal materials of the group.

14. The liquid crystal display device according to claim 9 further comprising a first polarizing plate arranged on an external surface of the first substrate and having a first absorption axis, and a second polarizing plate arranged on an external surface of the second substrate and having a second absorption axis in a Cross Nicol relationship with the first absorption axis, wherein the first absorption axis is substantially in parallel with the first direction or the second direction.
